(19) United States
(12) Patent Application Publication
(10) Pub. No.: US 2006/0064279 A1
(43) Pub. Date: Mar. 23, 2006

(54) Algorithm for retrieval of ocean surface temperature, wind speed and wind direction from remote microwave radiometric measurements

(76) Inventor: Eric Baum, Rancho Palos Verdes, CA (US)

Correspondence Address: Eric Baum, 29528 Oceanport Rd., Rancho Palos Verdes, CA, 90275, US

(21) Appl. No.: 10/943,671

(22) Filed: Sep. 17, 2004

(51) Int. Cl. G06F 17/00

(52) U.S. Cl. 702/182

(57) ABSTRACT

This invention is an improved algorithm for retrieving the sea surface temperature, wind speed and wind direction from a suite of remote microwave radiometer measurements of the brightness temperature of a patch of ocean. Advantages of the method over the prior art are: (1) improved spatial resolution, (2) reduced measurement noise and, (3) removal of a source of error in the modeled wind-direction-dependence of the brightness temperature.

The prior art (see references 1-2) referenced by this invention was funded by the U.S. government and there are no known associated patents. The present invention is an improved version of an earlier patent by the same inventor (see reference 3). This invention is the sole property of the inventor, receiving no support from any outside sources.

### BACKGROUND

The next-generation U.S weather satellite, the National Polar-orbiting Operational Environmental Satellite System (NPOESS), carries the Conical-scanning Microwave Imaging/Sounder (CMIS) instrument. One of the major deliverable products (Environmental Data Records, or EDRs) from this instrument's measurements is the ocean EDR suite that includes ocean surface (skin) temperature, and wind speed and direction over the ocean. An algorithm has already been chosen by which these EDRs are derived from a suite of radiometric measurements of brightness temperature [ref. 1-2]. Each “measurement” is characterized by a centerline radiometer wavelength and one of the 4 Stokes polarization components (1^{st}, 2^{nd}, 3^{rd} or 4^{th} Stokes), with the 3^{rd} and 4^{th} Stokes polarizations determined by 2 physical polarimetric brightness temperature measurements each. Measurements at 4 wavelengths are used to infer wind speed and direction (not all polarization components are measured so the number of physical measurements, n, is smaller than the fully-populated measurement array size of 24 measurements). The same n measurements plus two additional measurements at a 5^{th} wavelength are used to infer skin temperature. The existing algorithm (in its slower-but-better form) performs retrieval in the following sequence:
1. Retrieve skin temperature Tₛ using a regression; a statistical fit of data to a function that is quadratic in each of the n+2 measured brightness temperatures (at 5 radiometer frequencies).
2. Retrieve properties of the atmospheric column along the line-of-sight Pₐ (up-welling brightness temperature, down-welling brightness temperature and absorption coefficient) using a regression; a statistical fit of data at each frequency to a function that is linear in sea-surface-temperature and quadratic in the measured brightness temperatures at that frequency.
3. At small intervals in assumed wind direction, solve a model equation Tbᵢ=f(Tₛ, Pₐ, uw, φ) for each of the theoretical Stokes components at a nominal wind speed and then use Newton's method to find a minimum (wrt wind speed) in a figure-of-merit (FOM) of the agreement between theory and experiment. The FOM consists of the discrepancy between measured and modeled Stokes component, squared and summed over the measurements. The modeled brightness temperature is a function of skin temperature Tₛ, atmospheric properties Pₐ, wind speed uw and wind direction φ. Each candidate wind direction interval then has an associated wind speed and FOM. The candidate wind direction interval with the smallest FOM contains the most likely wind direction.

This invention addresses the following inherent weaknesses in the existing algorithm:
1. The 2 measurements at the 5^{th} radiometer wavelength that are used only in the skin temperature regression (but not elsewhere in the wind speed/direction algorithm) have an ocean surface footprint that is the largest of the 5 wavelengths. The spatial resolution of the other 4 radiometers must therefore be degraded (the measurements averaged over the largest of the footprints in the suite) in order to have all measurements refer to the same area of the ocean. This invention removes the need to use the 5^{th} radiometer wavelength for any of the ocean EDRs and thereby improves the spatial resolution.
2. The use of regressions to evaluate the ocean skin temperature and the atmospheric properties uses all of the available measurements to represent the physical phenomena inherent in the model equations Tbᵢ, and none can be considered redundant for the purpose of noise reduction. This invention eliminates the use of regressions. The result is that most of the measurements (as will be shown) are redundant and serve to beat down the measurement noise.
3. Evaluating the skin temperature and atmospheric properties through regressions is an imperfect process, with one of the residual errors being an artificial wind-direction-dependence of the retrieved skin temperature. This artificial directional dependence, when compared with the real directional dependence of the ocean surface emissivity in the model equations, could be large enough to become a confounding effect under some conditions. This invention evaluates the skin temperature directly from the model equations and so avoids the problem.
4. Evaluating the skin temperature and atmospheric properties through regressions (with the measurements as arguments) introduces a measurement noise component to the retrieved skin temperature and atmospheric properties.

These noise-associated retrieval errors can become a dominant source of error in the theoretical T_{bi} values.

### SUMMARY

This invention delays the evaluation of the skin temperature and atmospheric properties so that they are evaluated together with the wind speed at each candidate wind direction. The atmospheric properties are evaluated from a direct model, with arguments that include (in the simplest such model) Tₛ and the atmospheric columnar water vapor content V. The invention uses initial estimates of Tₛ, V and uw along with 4 evaluations of the model equations to numerically evaluate ∂Tbᵢ/∂Tₛ ∂Tbᵢ/∂V and ∂Tbᵢ/∂uw for each of the measurement channels. The first three terms in a Taylor's series of Tbᵢ(Tₛ,V,uw) are then used to generate an expression for Tbᵢ in the neighborhood of the initial estimates. A figure-of-merit is defined, with a minimum value determining the most likely values of skin temperature and wind speed; this FOM consisting of the difference between measured brightness temperature and Tbi from the Taylor's series, squared and summed over the measurement channels. The expression for this FOM is then minimized wrt Tₛ, V and uw to yield three algebraic equations linear in Tₛ, V and uw. This classic least-squares-optimization yields updated estimates of skin temperature, atmospheric water vapor and wind speed. Optionally, a final evaluation of the model equations using the updated Tₛ, V and uw values yields a more accurate evaluation of the Tbᵢ values and a better estimate of the FOM. After performing this process at all of the candidate wind directions, there has been generated an array of FOM, Tₛ, V and uw values vs wind direction. The final Tₛ, V, uw and wind direction best-guess-values correspond to the minimum FOM value.

### DESCRIPTION

For each measured brightness temperature Tbₘᵢ the corresponding theoretical brightness temperature in the neighborhood of estimated values Ts₀, V₀ and uw₀ is represented by the truncated Taylor's series
Tbᵢ≈f(Tₛ₀,V₀,uw₀,φ)+∂Tbᵢ/∂Tₛ(Tₛ−Tₛ₀)+∂Tbᵢ/V(V−V₀)+∂Tbᵢ/∂uw(uw−uw₀)+
The partial derivatives are evaluated numerically from evaluations of the model equations using perturbed arguments, f(Tₛ₀+ΔTₛ,V₀,uw₀,φ), f(Tₛ₀,V₀+ΔV,uw₀,φ) and f(Tₛ₀,V₀,uw₀+Δuw,φ). There are a large number (n) of these equations and three unknowns, Tₛ, V and uw. If only three of the equations were used to equate measurement to model, Tₛ, V and uw could be determined exactly. The remaining n-3 equations are redundant, but all n of the equations can be used by asking for a “best fit” instead of an exact solution; i.e. a classical least-squares-fit of Tbᵢ to Tbₘᵢ. The difference between measurement and theory is squared and summed over the n measurements to yield the FOM,
FOM=Σ[Tbᵢ−Tbₘᵢ]²
This is minimized wrt Tₛ, wrt V and wrt uw in turn:

$$0 = \sum [ {f}_{0 i} \frac{\partial {Tb}_{i}}{\partial {T}_{s}} + {( \frac{\partial {Tb}_{i}}{\partial {T}_{s}} )}^{2} ( {T}_{s} - {T}_{s0} ) + \frac{\partial {Tb}_{i}}{\partial {T}_{s}} \frac{\partial {Tb}_{i}}{\partial V} ( V - {V}_{0} ) + \frac{\partial {Tb}_{i}}{\partial {T}_{s}} \frac{\partial {Tb}_{i}}{\partial uw} ( uw - {uw}_{0} ) - \frac{\partial {Tb}_{i}}{\partial Ts} {Tb}_{mi} ]$$

$$0 = \sum [ {f}_{0 i} \frac{\partial {Tb}_{i}}{\partial V} + \frac{\partial {Tb}_{i}}{\partial {T}_{s}} \frac{\partial {Tb}_{i}}{\partial V} ( {T}_{s} - {T}_{s0} ) + {( \frac{\partial {Tb}_{i}}{\partial V} )}^{2} ( V - {V}_{0} ) + \frac{\partial {Tb}_{i}}{\partial V} \frac{\partial {Tb}_{i}}{\partial uw} ( uw - {uw}_{0} ) - \frac{\partial {Tb}_{i}}{\partial V} {Tb}_{mi} ]$$

$$0 = \sum [ {f}_{0 i} \frac{\partial {Tb}_{i}}{\partial uw} + \frac{\partial {Tb}_{i}}{\partial uw} \frac{\partial {Tb}_{i}}{\partial {T}_{s}} ( {T}_{s} - {T}_{s0} ) + \frac{\partial {Tb}_{i}}{\partial V} \frac{\partial {Tb}_{i}}{\partial uw} ( V - {V}_{0} ) + {( \frac{\partial {Tb}_{i}}{\partial uw} )}^{2} ( uw - {uw}_{0} ) - \frac{\partial {Tb}_{i}}{\partial uw} {Tb}_{mi} ]$$

These are a set of three linear algebraic equations of the form
a Tₛ+b V+c uw=d
that can be solved directly for those values Tₛ, V and uw that minimize the FOM. Because the model function fᵢ depends on the wind direction, the optimized values Tₛ, V and uw will vary slightly with wind direction. The candidate wind direction bin that results in the smallest minimized FOM is most likely to contain the true wind direction and the associated true values of Tₛ, V and uw.

### REFERENCES

1. T. Meissner and F. Wentz, The ocean algorithm suite for the Conical-scanning Microwave Imaging/Sounder (CMIS), Proceedings of the 2002 IEEE International Geoscience and Remote Sensing Symposium (IGARSS), Toronto, Canada
2. C. Smith, F. Wentz and T. Meissner, ATBD: CMIS Ocean EDR Algorithm Suite, Remote Sensing Systems, Santa Rosa, Calif. www.remss.com, 2001
3. Algorithm for retrieval of ocean surface temperature, wind speed and wind direction from remote microwave measurements, patent application Ser. No. 10/830,619, filed Apr. 23, 2004.

What is claimed is:

1. A method whereby some inherent weaknesses in the prior-art processes are improved by evaluating the ocean skin temperature Tₛ as an inferred-property and the atmospheric properties Pₐ from a model having only inferred properties (and no measurements) as arguments.

2. A detailed method by which Tₛ, uw and the Pₐ values are evaluated as inferred-properties; the most likely ocean skin temperature (Tₛ), wind speed (uw) and atmospheric properties (Pₐ) at a candidate wind direction (φ) can be evaluated from a number (n) of independent (different wavelengths and/or polarizations) remote measurements of the brightness temperature Tbᵢ of a patch of ocean, the method comprising the steps of:
a. estimating Ts, V (a proxy for the Pₐ values) and uw (when incrementing the candidate wind direction, the values of Tₛ and uw obtained at the previous candidate direction can be used, while other estimation methods can be used for the first candidate wind direction considered)
b. using a Taylor's series in powers of Tₛ, V and uw (truncated at the linear terms) to represent the brightness temperatures Tbᵢ for values of Tₛ, V and uw in the neighborhood of the estimated values, using a model equation Tbᵢ=f(Ts,V,uw,φ) to represent the brightness temperatures and evaluating the partial derivatives of brightness temperature wrt Tₛ, V and uw by finite differences (but these could alternatively be evaluated term-by-term within the model function f)
c. using 3 of the measurements, Tbmᵢ, equated to the modeled Tbᵢ of step b, to determine Tₛ, V and uw exactly, or preferably, using more than 2 measurements to evaluate a figure of merit (FOM) consisting of Σ (Tbᵢ−Tbₘᵢ)², then minimizing this FOM wrt Tₛ, V and uw in turn to produce the three equations needed to evaluate the corresponding optimized values of Ts, V and uw
d. considering the candidate wind direction bin that produces the smallest FOM to be the most likely to contain the true wind speed, and the corresponding values of skin temperature, atmospheric properties and wind speed obtained from step c to be the best estimates thereof.

3. Claim 2 altered by using alternate methods of obtaining the initial estimates Tₛ₀, V₀ and uw₀.

4. Claim 2 altered by using expansions of Tbᵢ (Ts,uw;φ) that are higher order than linear in Tₛ, V and uw.

5. Claim 2 altered by using methods of convergence toward a minimum FOM that don't rely on the local expansion, such as the method of steepest descent.

6. Claim 2 altered by using other functions of Tbᵢ−Tbₘᵢ as the FOM.

7. Any permutations of the preferred and alternate embodiments of claims 2-6.

8. Any other direct model for the atmospheric properties Pₐ (used in claims 1 and 2) that can be characterized by additional parameters (other than Tₛ and V), such as the columnar atmospheric liquid water content, characteristic thickness of the atmospheric column, . . . with the understanding that each additional parameter will require the solution of an additional simultaneous linear algebraic equation minimizing the FOM wrt that parameter.
